(19) United States
(12) Patent Application Publication
(10) Pub. No.: US 2007/0113200 A1
(43) Pub. Date: May 17, 2007

(54) On-screen control of a video playback device

(75) Inventor: Fons Schipper, Stramproy (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/586,935

(22) PCT Filed: Jan. 27, 2005
(86) PCT No.: PCT/IB05/50358

§ 371 Date: Jul. 24, 2006

Related U.S. Application Data
(60) Provisional application No. 60/540,902, filed on Jan. 29, 2004.

(51) Int. Cl. G06F 17/00; G06F 3/00; H04N 5/44

(52) U.S. Cl. 715/810; 715/716; 715/764

(57) ABSTRACT

A video playback device includes a controller and an on-screen display processor for displaying icons on a display representing all of the playback control functions of the video playback device. A cursor for selecting the desired playback control function is controlled by cursor movement keys on a remote control unit. The controller is also able to apply control signals selected by the remote control unit to an auxiliary video playback device connected to the video playback device.

### FIELD OF THE INVENTION

The subject invention relates to controlling a video playback device, and more particularly, to controlling the video playback device via on-screen icons.

### DESCRIPTION OF THE RELATED ART

Typically, a video playback device is controlled through the use of a wireless remote control unit. Dedicated keys are present on the remote control unit to control the playback control modes, e.g., PLAY, STOP, PAUSE, SLOW FORWARD PLAY, FAST FORWARD PLAY, SLOW REVERSE PLAY, FAST REVERSE PLAY, FAST WIND, REWIND, etc. Examples of such a video playback device is a VCR or a DVD-RW recorder. However, in order to reduce the number of keys on the remote control unit, various function are often combined in a single key. For example, slow forward, fast forward and fast wind may be combined in a single key in which, when in the PLAY mode, if the single key is pressed instantaneously, the device goes into the FAST FORWARD PLAY mode, while if the single key is pressed and held down, the device goes into the SLOW FORWARD PLAY mode. Further, if the STOP mode is in effect, by pressing the same single key, the device goes into the FAST WIND mode. Furthermore, the combinations of these functions are not the same between different video playback devices from different manufacturers, and even among different models from the same manufacturer.

As such, the use of the remote control for video playback devices is not always intuitive to the user and often the user needs to repeatedly look at the remote control unit to figure out which key needs to be pressed, and, in many instances, the user even needs to refer to the Owner's Manual to be able to fully utilize all of the playback control options available in controlling the video playback device.

In an attempt to alleviate this condition, some video playback devices offer limited on-screen icons for controlling the video playback device. However, various menus need to be “called up” to display the various control options. Further, there is often no provisions for controlling an auxiliary video playback device connected to the video playback device, for example, a camcorder connected to a DVD+RW recorder.

It is an object of the invention to provide a video playback device in which all of the playback control functions thereof are displayed as icons on a display screen, and a desired playback control function is effected by selecting the appropriate screen icon.

The above object is achieved in a video playback device including means for on-screen control of playback control functions of said video playback device, said means for on-screen control comprising means for generating, for display, a plurality of icons representing all of the playback control functions of said video playback device; means for moving a cursor among said plurality of icons in order to indicate a desired one of said plurality of icons; means for selecting said desired one of said plurality of icons; and means for enabling the playback control function represented by the selected one of said plurality of icons.

With the subject invention, a user is able to control all of the playback control functions of a video playback device merely by viewing the playback control function options on the display screen and by operating cursor control keys on a remote control unit for selecting a desired playback control function.

With the above and additional objects and advantages in mind as will hereinafter appear, the invention will be described with reference to the accompanying drawings, in which:

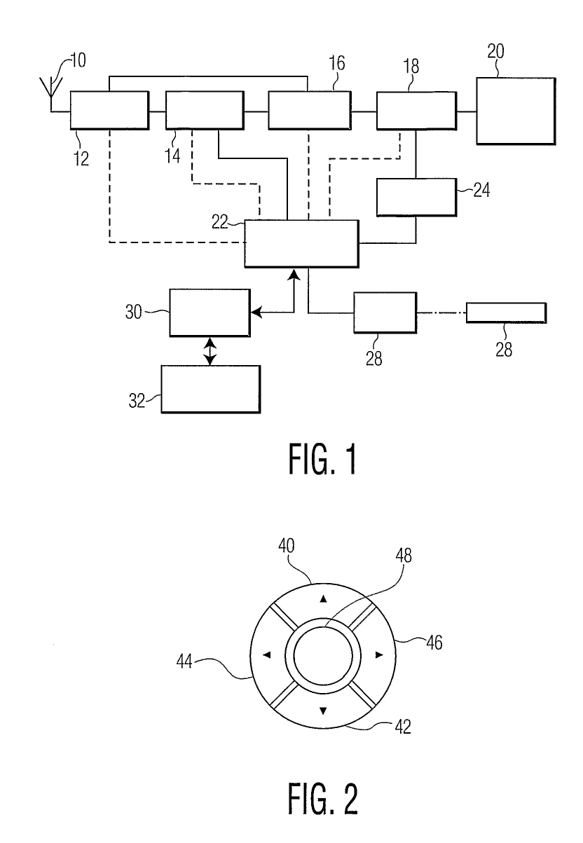

FIG. 1 shows a block schematic diagram of a video playback device incorporating the subject invention;

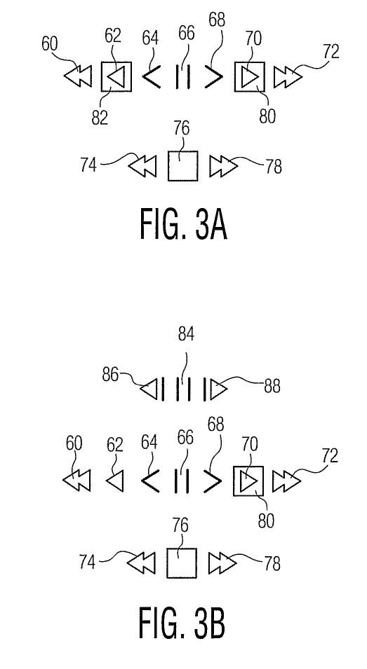

FIG. 2 shows a portion of a remote control device for use with the video playback device of FIG. 1; and

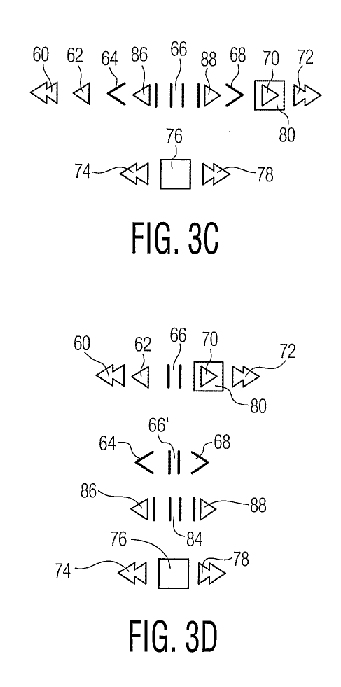

FIGS. 3A-3D show various embodiments of arrangement of icons as displayed by the video playback device of FIG. 1.

FIG. 1 shows a block schematic diagram of a video playback device. The video playback devices receives television signals via an input shown as antenna 10. While an antenna is shown, it should be understood that the input may be a self-contained video signal source, e.g., a video tape or a DVD, or some other external source, e.g., cable, satellite, etc. A tuner 12 is shown connected to the antenna 10 for selecting one of the television signals. A digital decoder 14 receives a digital television signal from the tuner 12, decodes this digital television signal, and applies corresponding video signals to video signal processor 16. In the event that the tuner 12 selects an analog television signal, the tuner 12 directly provides the corresponding video signals to the video signal processor 16.

The video signal processor 16 applies various processing to the video signals, including contrast, brightness and color adjustments. An output from the video signal processor 16 is applied through a video switch 18 to a display screen 20.

A controller 22 is included for controlling the tuner 12, the digital decoder 14 and the video signal processor 16. In order to provide on-screen messages to a user of the video playback device, the controller 22 applies message signals to an on-screen display processor 24 which, in turn, applies appropriate message video signals to the video switch 18. The controller 22 then controls the video switch 18 to place the message video signals from the on-screen display processor 24 into the video signal stream from the video switch 18 applied to the display screen 20.

The controller 22 receives user control signals from an infrared receiver 26 which, in turn, receives infrared control signals from a remote control unit 28 operable by the user. In addition, the controller 22 is connected to an input/output (I/O) interface 30 for receiving digital video signals from, for example, a digital camcorder 32. To that end, the controller further provides these digital video signals to the digital decoder 14. The I/O interface 30 may be in the form of an i.link™ which provides a high-speed, bi-directional digital link to/from the controller 22. As such, the controller 22 is able to send playback control signals to the camcorder 32.

The remote control unit 28 includes a keypad having various numeric keys (not shown) for directly inputting television channels, as well as keys (not shown) for scanning the television channels. Further, as shown in FIG. 2, the remote control unit 28 includes cursor control keys 40, 42, 44 and 46 for moving a cursor up, down, left and right on the display screen 20, as well as a SELECT key 48 for selecting a function indicated by the position of the cursor.

FIG. 3A shows the icons of the playback control functions for the video playback device as displayed on the display screen 20 under control of the controller 22. These playback control functions include FAST REVERSE PLAY 60, REVERSE PLAY 62, SLOW REVERSE PLAY 64, PAUSE 66, SLOW FORWARD PLAY 68, FORWARD PLAY 70 FAST FORWARD PLAY 72, REWIND 74, STOP 76 and FAST WIND 78. A highlight 80 is shown around the currently active playback control mode, in this case FORWARD PLAY 70. A desired playback control mode is selected by a user by merely using his/her thumb to operate the cursor control keys 40-46 and the SELECT key 48 on the remote control unit 28. The movement of the cursor is indicated by a box 82 surrounding the desired playback control mode (in this case REVERSE PLAY 62). As such, the user need not look at the remote control unit 28, but rather at the display screen 20 which displays the relevant video program overlaid by the icons of the playback control functions for the video playback device.

It should be noted that due to external events, the highlight 80 indicating the current playback control mode may not instantaneously switch to the desired playback control mode (indicated by the box 82). For example, if the current playback control mode is FORWARD PLAY 70 (as shown by highlight 80) while the desired playback control mode is REVERSE PLAY (as shown by box 82), there will be a slight delay for the video playback device to stop PLAY in the forward direction and to initiate PLAY in the reverse direction.

As an alternative to pressing the SELECT key 48, the desired playback control mode may be selected by the user merely moving the cursor to the desired playback control mode. In this case, for the arrangement shown in FIG. 3A, from the FORWARD PLAY control mode, the user merely presses the left cursor key 4 times, thereby moving the box 82 to the icon 62.

The playback control icon layout shown in FIG. 3A does not support frame stepping, i.e., moving from one frame to a following or preceding frame while in the PAUSE playback control mode. FIG. 3B shows an alternate playback control icon layout in which the frame stepping function is supported and shown in a separate row. In particular, PAUSE is shown repeated at 84, along with REVERSE STEP 86 and FORWARD STEP 88. When the current playback control mode is PAUSE 84 (to be indicated by the highlight 80), and the user presses the right cursor key 46, the highlight 80 temporarily moves to the FORWARD STEP icon 88 and then shifts back to the PAUSE icon 84. This operation similarly occurs with respect to REVERSE STEP 86. When the video playback device is in any of the playback control modes indicated by the icons in the middle row, by the user pressing the UP cursor control key 40, the video playback device goes into the PAUSE 84 mode. Conversely, by the user pressing the DOWN cursor control key 42, the video playback device goes into the STOP 76 mode.

FIG. 3C shows an alternate playback control icon layout to that shown in FIG. 3B in which the frame stepping functions are integrated into the top row as shown in FIG. 3A.

In a further alternate playback control icon layout, FIG. 3D shows the icon layout in four rows, in which the FORWARD/REVERSE PLAY icons (70/62) are directly adjacent to the PAUSE icon 66, enabling a fast change from PLAY to PAUSE.

Numerous alterations and modifications of the structure herein disclosed will present themselves to those skilled in the art. However, it is to be understood that the above described embodiment is for purposes of illustration only and not to be construed as a limitation of the invention. All such modifications which do not depart from the spirit of the invention are intended to be included within the scope of the appended claims.

1. A video playback device including means for on-screen control of playback control functions of said video playback device, said means for on-screen control comprising:
means (24) for generating, for display, a plurality of icons (60-78) representing all of the playback control functions of said video playback device;
means (28, 40-46) for moving a cursor (82) among said plurality of icons (60-78) in order to indicate a desired one of said plurality of icons (60-78);
means (48) for selecting said desired one of said plurality of icons (60-78); and
means (22) for enabling the playback control function represented by the selected one of said plurality of icons (60-78).

2. The video playback device as claimed in claim 1, wherein said moving means and said selecting means is a remote control unit (28) having cursor control keys (40-48).

3. The video playback device as claimed in claim 1, wherein said generating means further comprises:
means (80) for indicating which one of said playback control functions as represented by said plurality of icons (60-78), is currently active.

4. The video playback device as claimed in claim 2, wherein said selecting means (48) further comprises:
means (82) for indicating said desired selection on said selected icon.

5. The video playback device as claimed in claim 1, wherein said video playback device comprises:
a controller (22) for receiving video signals from an auxiliary video playback device (32) having playback control functions, said controller (22) further generating playback control signals for controlling all of the playback control functions of said auxiliary video playback device (32);
an input/output interface (30) for connecting to an auxiliary video playback device (32), said input/output interface (30) supplying said received video signals to said controller (22) and receiving said playback control signals from said controller (22); and
means (22) for switching said generating means (24) to generate, for display, a plurality of icons representing the playback control functions of said auxiliary video playback device (32).
